(19) United States
(12) Patent Application Publication
(10) Pub. No.: US 2006/0273737 A1
(43) Pub. Date: Dec. 7, 2006

(54) Electronic ballast for at least one lamp

(75) Inventor: Markus Heckmann, Munchen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/445,184

(22) Filed: Jun. 2, 2006

(30) Foreign Application Priority Data
Jun. 3, 2005 (DE) 102005025626.0

(51) Int. Cl. H05B 39/04

(52) U.S. Cl. 315/209 R

(57) ABSTRACT

The present invention relates to an electronic ballast for at least one lamp (La) having at least one first switch (S1), the first switch (S1) having at least one working terminal (A1), a reference terminal (B1) and a control input terminal (St1), and at least one auxiliary unit (10), the auxiliary unit (10) having a supply terminal (V1), the supply terminal (V1) of the auxiliary unit (10) being coupled to the working terminal (A1) of the first switch (S1) via a supply unit (12), which comprises at least one inductance (L2).

### FIELD OF THE INVENTION

The present invention relates to an electronic ballast for at least one lamp having at least one first switch, the first switch having at least one working terminal, a reference terminal and a control input terminal, and having at least one auxiliary unit, the at least one auxiliary unit having a supply terminal.

### BACKGROUND OF THE INVENTION

Such electronic ballasts are known from the relevant prior art, it being possible for the auxiliary unit to assume different functions, for example for it to take on the function of driving the at least one first switch, carry out end-of-life monitoring, monitoring for overvoltages, for excessive temperatures or for carrying out a wide variety of control tasks, etc.

In the case of a large number of electronic ballasts known from the prior art, a second switch is provided in addition to the first switch, and this second switch is arranged together with the first switch in a half-bridge arrangement. In this case, the half-bridge center point is connected to the lamp load circuit. Moreover, a so-called snubber capacitor (trapezoidal capacitor) is connected to the center point of the half-bridge arrangement in order to make zero voltage switching of the two switches possible. It is now known to use the energy stored in the snubber capacitor for the supply to the auxiliary unit. However, this practice is only successful if the lamp load circuit has sufficient reactive energy available. In particular in the case of ballasts having a lower power rating and in the case of single-flame electronic ballasts, the snubber capacitor may often not have sufficiently large dimensions since this would entail a capacitive load on the half-bridge arrangement which would be too great. This would result, in an undesirable manner, in high losses in the lamp inductor and in the switches, which would therefore have to have larger dimensions.

In order nevertheless to ensure that there is sufficient supply to auxiliary units, it is known from the prior art to use energy from the resonant capacitor, which is arranged in the lamp load circuit and is required for starting the lamp, for the supply to the auxiliary units. However, this solution is very uneconomical in the case of multiwatt devices and also often leads to thermal problems. In addition, during starting of the lamp, very high loads occur in the components, which are used for stabilizing the supply voltage of the respective auxiliary unit.

### SUMMARY OF THE INVENTION

The object of the present invention therefore consists in developing an electronic ballast mentioned at the outset such that a reliable power supply is made possible for at least one auxiliary unit, which at the same time should subject the rest of the circuit structure to as little load as possible.

First of all, the present invention is based on the knowledge that, with the procedure known from the prior art using a snubber capacitor, in terms of energy only the supply voltage of the auxiliary unit, for example 16 volts, multiplied by the charge on the snubber capacitor is used. However, in terms of energy, half the half-bridge voltage squared and multiplied by the charge on the snubber capacitor is provided by the half-bridge arrangement. Since the voltage at the half-bridge center point is of the order of magnitude of over 200 volts, there is poor utilization of the available energy. In particular, the ratio of the obtained energy divided by the absolute value for the capacitive load is poor. The invention is based in particular on the concept of not subjecting the lamp load circuit to a further capacitive load but of using at least one inductance for the purpose of outputting energy for the supply to the at least one auxiliary unit. In this case, energy is stored in the inductance and is slowly output again when the inductance is demagnetized. Since the integral of the energy is critical for the amount of current produced, in this case (in contrast to in the case of the capacitor in which the provision of energy, i.e. discharging of the capacitor, is the process which takes place rapidly) inductive loading can be extended over a relatively long period of time and as a result has a considerably less negative effect.

In the preceding text, the problem and basic solution have been illustrated using the example of an electronic ballast having a lamp load circuit, for reasons of better understanding, in which case the working terminal of the at least one switch is coupled to the lamp load circuit. However, there are also electronic ballasts in which only one switch operates a lamp load circuit. These ballasts are known under the designation of Class E converters. As is obvious to a person skilled in the art, the present invention can also be used in this field and moreover in other fields, for example if the first switch is part of an active circuit unit, in particular an active circuit unit for power factor correction.

In the mentioned example, having two switches, the second switch in particular also comprises at least one working terminal, a reference terminal and a control input terminal, the working terminal of the second switch being coupled to the working terminal of the first switch so as to form a bridge circuit, the center point of the bridge circuit being defined by the coupling between the working terminal of the first switch and the working terminal of the second switch.

The supply unit preferably comprises an LC resonant circuit, the inductance being part of this LC resonant circuit. In particular in the case of a design in the form a series resonant circuit, the capacitor may have small dimensions since the polarity-reversal process, i.e. the transition from a state in which the first switch is closed and the second switch is open to a state in which the first switch is open and the second switch is closed not only provides the polarity-reversal charge for this capacitor but also stores energy in the inductance, which energy can also be passed on to the auxiliary unit after the polarity-reversal process. In general, such a supply unit can provide all of the power supply for the auxiliary unit, i.e. without any additional use of a snubber capacitor.

The supply unit particularly preferably comprises the series circuit comprising a first capacitor, the inductance and a first diode, the connection point between the inductance and the first capacitor being coupled to a reference potential via a voltage limitation apparatus, in particular a second diode, a zener diode and/or a varistor. In this case, the first diode ensures that current flow is only made possible in the feed-in direction. The voltage limitation apparatus limits charging of the inductor. In this case, the voltage limitation apparatus is preferably designed to limit the voltage step at the connection point between the first capacitor and the inductance to a predeterminable limit value.

In one preferred development of the embodiment just mentioned, the connection point between the inductance and the first diode is coupled to the reference potential via a third diode. This third diode is used for clamping a parasitic oscillation which may be present.

In one further preferred embodiment, the supply terminal of the auxiliary unit is also coupled to the working terminal of the first switch via the series circuit comprising a second capacitor and a fourth diode, the connection point between the second capacitor and the fourth diode being coupled to a reference potential via a fifth diode. This measure makes it possible to use an additional snubber capacitor for the supply to the auxiliary unit.

Further preferred embodiments result from the dependent claims.

### BRIEF DESCRIPTION OF THE DRAWINGS

Two exemplary embodiments of the invention will be described in more detail below with reference to the attached drawings, in which:

FIG. 1 shows a schematic illustration of a first embodiment of an electronic ballast according to the invention, only those components which are relevant to the invention being illustrated; and

FIG. 2 shows a schematic illustration of a second embodiment of an electronic ballast according to the invention, likewise only those components which are relevant to the invention being illustrated.

### DETAILED DESCRIPTION OF THE INVENTION

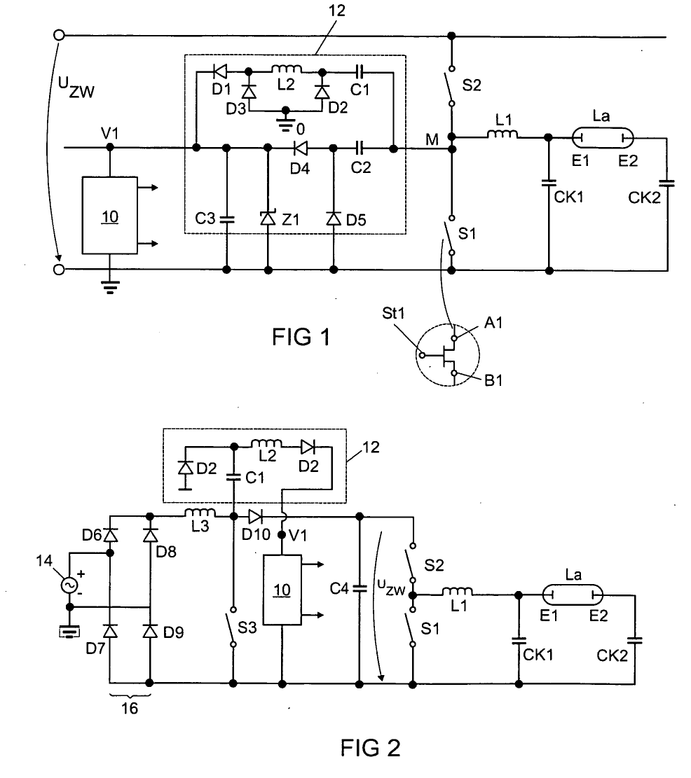

FIG. 1 shows a schematic illustration of the detail, which is relevant to the present invention, of an electronic ballast according to the invention. In this case, a lamp La is connected to the center point M of a half-bridge circuit via an inductance L1, said half-bridge circuit comprising the switches S1 and S2. Each switch S1, S2 has a working terminal, a reference terminal and a control input terminal, only the terminals for the switch S1 being illustrated in the enlarged illustration in FIG. 1, that is to say the working terminal A1, the reference terminal B1 and the control input terminal St1. In the case of the switch S2, the working terminal and the reference terminal are swapped over in comparison to the switch S1, i.e. the reference terminal is at the top, the working terminal is at the bottom, i.e. both working terminals are connected to the half-bridge center point M. Both electrodes E1, E2 of the lamp La are connected to the ground potential, as the reference potential, via coupling capacitors C_{K1} and C_{K2}. An auxiliary unit 10, which takes on the function of driving the two switches S1 and S2, as is expressed by the two arrows, has a supply terminal V1. A supply unit 12 is connected between the half-bridge center point M and the supply terminal V1 of the auxiliary unit 10. It comprises the series circuit comprising a capacitor C1, an inductance L2 and a first diode D1. In this case, the capacitor C1 and the inductance L2 form an LC resonant circuit. The connection point between the inductance L2 and the capacitor C1 is coupled to a reference potential, in this case a ground potential, via a voltage limitation apparatus, in this case a diode D2. This diode D2 is used for limiting the voltage step at the connection point between the capacitor C1 and the inductance L2 to a predeterminable limit value. The connection point between the inductance L2 and the diode D1 is likewise coupled to the reference potential via a diode D3, as a result of which it is possible to eliminate parasitic oscillations in the supply signal.

In addition to the supply branch, which comprises the components C1, D2, L2, D3 and D1, a further supply branch may be provided between the half-bridge center point M and the supply terminal V1 of the auxiliary unit 10: for this purpose, a capacitor C2, also referred to as a so-called snubber capacitor at this point, is connected to the supply terminal V1 via a diode D4. A diode D5 makes it possible to recharge the capacitor C2, and a zener diode Z1 is used for limiting the voltage to a predetermined value. Moreover, a capacitor C3 may be provided in order to ensure the supply to the auxiliary unit 10 of a supply voltage which is as constant as possible.

FIG. 2 shows a further embodiment of an electronic ballast according to the invention. In this case, components which correspond to those in FIG. 1 are identified by corresponding reference symbols and will not be described again. This circuit has an active system input part and is connected on the input side to an AC voltage source 14. The AC voltage signal is rectified in a rectifier 16, which comprises the diodes D6 to D9, passes through the series circuit comprising an inductance L3 and a diode D10 and is ultimately provided at a capacitor C4 as the intermediate circuit voltage U_{ZM} of the half-bridge arrangement having the switches S1 and S2, see also FIG. 1 in this regard. For the supply to the auxiliary unit 10, the supply unit 12, which in this case comprises the capacitor C1, the diodes D1 and D2 and the inductance L2, is connected to the working terminal of a switch S3. In the circuit arrangement in FIG. 2, the switch S3, the diode D10 and the inductance L3 form a boost converter. In this case, energy is stored in the inductance L3 as long as the switch S3 is closed. Once the switch S3 has opened, this energy is stored inductively in the output circuit.

1. An electronic ballast for at least one lamp (La) having
at least one first switch (S1), the first switch (S1) having at least one working terminal (A1), a reference terminal (B1) and a control input terminal (St1); and
at least one auxiliary unit (10), the auxiliary unit (10) having a supply terminal (V1);
characterized
in that the supply terminal (V1) of the auxiliary unit (10) is coupled to the working terminal (A1) of the first switch (S1) via a supply unit (12), which comprises at least one inductance (L2).

2. The electronic ballast as claimed in claim 1, characterized
in that a lamp load circuit is coupled to the working terminal (A1).

3. The electronic ballast as claimed in claim 1, characterized
in that the first switch (S1) is part of an active circuit unit, in particular an active circuit unit for power factor correction.

4. The electronic ballast as claimed in claim 1, characterized
in that it also comprises at least one second switch (S2), the second switch (S2) having at least one working terminal (A2), a reference terminal (B2) and a control input terminal (St2), the working terminal (A2) of the second switch (S2) being coupled to the working terminal (A1) of the first switch (S1) so as to form a bridge circuit, a center point of the bridge circuit being defined by the coupling between the working terminal (A1) of the first switch (S1) and the working terminal (A2) of the second switch (S2).

5. The electronic ballast as claimed claim 1, characterized
in that the supply unit (12) comprises an LC resonant circuit, the inductance (L2) being part of this LC resonant circuit.

6. The electronic ballast as claimed in claim 5, characterized
in that the supply unit (12) comprises the series circuit comprising a first capacitor (C1), the inductance (L2) and a first diode (D1), the connection point between the inductance (L2) and the first capacitor (C1) being coupled to a reference potential via a voltage limitation apparatus, in particular a second diode (D2), a zener diode (Z1) and/or a varistor.

7. The electronic ballast as claimed in claim 6, characterized
in that the voltage limitation apparatus is designed to limit the voltage step at the connection point between the first capacitor (C1) and the inductance (L2) to a predeterminable limit value.

8. The electronic ballast as claimed in claim 6, characterized
in that the connection point between the inductance (L2) and the first diode (D1) is coupled to the reference potential via a third diode (D3).

9. The electronic ballast as claimed in claim 7, characterized
in that the supply terminal (V1) of the auxiliary unit (10) is also coupled to the working terminal (A1) of the first switch (S1) via the series circuit comprising a second capacitor (C2) and a fourth diode (D4), the connection point between the second capacitor (C2) and the fourth diode (D4) being coupled to a reference potential via a fifth diode (D5).

10. The electronic ballast as claimed in claim 7, characterized
in that the connection point between the inductance (L2) and the first diode (D1) is coupled to the reference potential via a third diode (D3).
